(19) United States
(12) Patent Application Publication
(10) Pub. No.: US 2026/0162449 A1
(43) Pub. Date: Jun. 11, 2026

(54) Systems and Methods for Automated Semantic Segmentation and Label Generation

(71) Applicant: California Institute of Technology, Pasadena, CA (US)

(72) Inventors: Soon-Jo Chung, La Canada, CA (US); Connor T. Lee, Arcadia, CA (US); Matthew JL Anderson, Pasadena, CA (US); Saraswati Soedarmadji, Los Angeles, CA (US)

(73) Assignee: California Institute of Technology, Pasadena, CA (US)

(21) Appl. No.: 19/178,705

(22) Filed: Apr. 14, 2025

Related U.S. Application Data
(60) Provisional application No. 63/633,556, filed on Apr. 12, 2024.

(51) Int. Cl. G06V 20/70; G06T 7/12; G06T 7/70; G06T 17/05; G06V 10/764; G06V 20/17

(52) U.S. Cl. CPC G06V 20/70; G06T 7/12; G06T 7/70; G06T 17/05; G06V 10/764; G06V 20/17

(57) ABSTRACT

Systems and methods for automated semantic segmentation and label generation in accordance with embodiments of the invention are illustrated. One embodiment includes a method for generating labeled data for semantic segmentation. The method includes receiving an input image of a geographic region captured by a camera on an aerial vehicle during flight, and obtaining pose data associated with the aerial vehicle. The method further includes generating a 3D semantic map of a geographic region corresponding to the geographic region in the input image, projecting the 3D semantic map onto an input image frame using the pose data to generate a projected semantic label that aligns semantic classifications of the 3D semantic map with corresponding regions in the input image, and refining the projected semantic label using a visual model conditioned on features of the input image to generate an output semantic segmentation label.

### CROSS-REFERENCE TO RELATED APPLICATIONS

The current application claims the benefit of and priority under 35 U.S.C. § 119(e) to U.S. Provisional Patent Application No. 63/633,556 entitled “Automated Semantic Segmentation Label Generation from Satellite-Derived Data Products” filed Apr. 12, 2024, the disclosures of which are hereby incorporated by reference in their entirety for all purposes.

### STATEMENT OF FEDERAL FUNDING

This invention was made with government support under Grant No(s). N00014-21-1-2374 & N00014-23-1-2518 awarded by the Office of Naval Research. The government has certain rights in the invention.

### FIELD OF THE INVENTION

The present invention generally relates to computer vision, and, more specifically, automatic label generation for semantic segmentation.

### BACKGROUND

Machine learning (ML) is a type of artificial intelligence that enables computers to learn from data and make decisions without being explicitly programmed. Unlike traditional software, which relies on predefined rules and logic, ML systems are designed to analyze vast amounts of information, recognize patterns, and adapt based on experience. ML systems can evolve by learning from new data, thereby continually enhancing their accuracy and performance. This ability to learn and adapt is powered by sophisticated algorithms that process and interpret data in meaningful ways. Through the use of statistical methods, ML models extract insights, generate predictions, and automate decision-making with minimal human input. From image classification and language translation to financial forecasting and personalized recommendations, ML converts raw data into valuable insights, establishing itself as a critical asset across various industries.

Computer vision is a field of artificial intelligence that enables computers to interpret and understand visual information from the world, such as images and videos. It involves techniques for detecting, classifying, segmenting, and tracking objects within visual data, often mimicking human visual perception. Applications of computer vision span across industries, including autonomous vehicles, medical imaging, remote sensing, surveillance, robotics, and augmented reality, where machines are required to extract meaningful insights from visual inputs for decision-making or interaction.

Semantic segmentation is a computer vision task that involves classifying each pixel in an image into a specific category. Unlike basic image classification or object detection, which assign labels to whole images or use bounding boxes, semantic segmentation is able to provide detailed, pixel-level understanding of visual scenes. This pixel-level understanding is made possible through machine learning, particularly through deep learning models such as convolutional neural networks (CNNs). These models are able to learn to recognize spatial hierarchies and contextual cues in the training data. Semantic segmentation is especially important in fields that require precise spatial information, such as autonomous driving, medical imaging, and environmental monitoring.

### SUMMARY OF INVENTION

Systems and methods for automated semantic segmentation and label generation in accordance with embodiments of the invention are illustrated. One embodiment includes a method for generating labeled data for semantic segmentation. The method includes receiving an input image of a geographic region captured by a camera on an aerial vehicle during flight, and obtaining pose data associated with the aerial vehicle. The method further includes generating a 3D semantic map of a geographic region corresponding to the geographic region in the input image, projecting the 3D semantic map onto an input image frame using the pose data to generate a projected semantic label that aligns semantic classifications of the 3D semantic map with corresponding regions in the input image, and refining the projected semantic label using a visual model conditioned on features of the input image to generate an output semantic segmentation label.

In another embodiment, the input image includes a thermal image, an RGB image, and a near-infrared image.

In a further embodiment, the pose data associated with the aerial vehicle includes location and orientation parameters corresponding to the location of the input image.

In still another embodiment, the 3D semantic map and the pose data associated with the aerial vehicle are transformed into a common coordinate system.

In a still further embodiment, the common coordinate system is a Universal Transverse Mercator (UTM) coordinate system.

In yet another embodiment, the 3D semantic map includes land cover classifications and elevation data of the geographic region, wherein the elevation data is assigned to each pixel of the 3D semantic map.

In a yet further embodiment, the 3D semantic map includes data selected from the group consisting of: Dynamic World land use and land cover data (LULC), OpenEarthMap-derived LULC, and Chesapeake Bay Program-derived LULC.

In another additional embodiment, the visual model includes a foundation model configured to output a binary mask based on the input image, and wherein the foundation model is a Segment Anything Model (SAM).

In a further additional embodiment, refining the projected semantic label includes generating a plurality of binary masks from the input image using the visual model, for each binary mask, determining a most-frequent class label based on the projected semantic label, and assigning the most-frequent class label to all pixels within the binary mask.

In another embodiment again, the projection of the semantic map includes applying a transformation based on parameters of the camera and elevation data derived from a digital elevation model (DEM).

In a further embodiment again, further including preprocessing the input image by applying intensity normalization and contrast-limited adaptive histogram equalization.

In still yet another embodiment, the refined semantic segmentation label is used to train a machine learning model for real-time semantic perception in a field robotics system.

In a still yet further embodiment, further including refining the LULC data using a dense conditional random field (CRF) model prior to projecting the LULC data into the input image frame, wherein the CRF is conditioned on high-resolution satellite imagery.

In still another additional embodiment, the projection of the semantic map includes transforming each coordinate of a relevant portion of the semantic map to the input image frame using a combination of a camera intrinsic matrix of the camera on the aerial vehicle, a rotational matrix, and a translation vector.

One embodiment includes a non-transitory machine readable medium containing processor instructions, where execution of the instructions by a processor causes the processor to perform a process for generating labeled data for semantic segmentation. The process includes receiving an input image of a geographic region captured by a camera on an aerial vehicle during flight, and obtaining pose data associated with the aerial vehicle. The process further includes generating a 3D semantic map of a geographic region corresponding to the geographic region in the input image, projecting the 3D semantic map onto an input image frame using the pose data to generate a projected semantic label that aligns semantic classifications of the 3D semantic map with corresponding regions in the input image, and refining the projected semantic label using a visual model conditioned on features of the input image to generate an output semantic segmentation label.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates a process for generating semantic segmentation labels for input images in accordance with an embodiment of the invention.

FIG. 2 illustrates a method for automatically generating semantic segmentation labels based on aerial thermal imagery in accordance with an embodiment of the invention.

FIGS. 3A-3B illustrate dense conditional random field (CRF) refinements of Dynamic World land cover raster using NAIP and PlanetScope imagery of Castaic Lake, CA in accordance with an embodiment of the invention.

FIG. 4 illustrates an algorithm for SAM-based label refinement in accordance with an embodiment of the invention.

FIG. 5 illustrates a mapping of the original and consolidated segmentation labels in accordance with an embodiment of the invention.

FIG. 6 illustrates an evaluation of dense CRF refinement of Dynamic World LULC on NAIP imagery with ground truth labels from CBP in accordance with an embodiment of the invention.

FIG. 7 illustrates an evaluation of LULC-generated semantic segmentation label against ground truth labels, with comparisons against zero-shot visual foundation model baselines in accordance with an embodiment of the invention.

FIG. 8 illustrates a series of example semantic segmentation outputs generated using a baseline method, the disclosed method, and manually annotated ground truth in accordance with an embodiment of the invention.

FIG. 9 illustrates a rendered label refinement process with SAM in accordance with an embodiment of the invention.

FIG. 10 illustrates data of ablation studies in accordance with an embodiment of the invention.

FIG. 11 illustrates the effects of LULC spatial resolution on semantic segmentation label generation in accordance with an embodiment of the invention.

FIG. 12 illustrates the effects of global pose estimate precision on semantic segmentation label generation with SAM refinement in accordance with an embodiment of the invention.

FIG. 13 illustrates test results of semantic segmentation networks trained on LULC-generated labels and networks trained on manually annotated ground truth in accordance with an embodiment of the invention.

FIG. 14 illustrates a network architecture for generating labels for semantic segmentation using thermal imagery for training and inference tasks in accordance with an embodiment of the invention.

FIG. 15 illustrates a computing device that can be utilized to generate semantic segmentation labels using thermal imagery for training and inference tasks in accordance with an embodiment of the invention.

FIG. 16 illustrates a label generation server that can be utilized to generate semantic segmentation labels using thermal imagery for training and inference tasks in accordance with an embodiment of the invention.

FIG. 17 illustrates a generation application for generating semantic segmentation labels using thermal imagery for training and inference tasks in accordance with an embodiment of the invention.

### DETAILED DESCRIPTION

Semantic segmentation has become essential in applications such as autonomous driving, robotic navigation, medical diagnostics, and environmental monitoring due to its ability to produce dense and structured predictions. In order to train a model to accurately perform pixel-level classification, it must first be shown labeled examples that map each pixel to a specific class. These labels serve as the “ground truth” that models learn from, providing the foundation for training accurate segmentation systems. In fact, the process of generating labeled datasets closely mirrors the task of semantic segmentation itself—both involve assigning class labels at the pixel level and require a detailed understanding of scene content. Without this granular labeling, it would be very difficult to train models to make similarly precise predictions.

Current methods for semantic segmentation heavily depend on manual labeling, requiring human annotators to meticulously classify each pixel in an image manually. These approaches primarily use RGB images, which capture color information across red, green, and blue channels. The prevalence of RGB data is largely due to its ubiquity-nearly all consumer and industrial cameras produce RGB output-making it the most accessible format for large-scale dataset collection. RGB images also offer rich visual cues like color, contrast, and texture, which are vital for distinguishing object classes. Consequently, most computer vision infrastructure-datasets, models, and benchmarks—has been built around RGB inputs. However, while RGB images offer significant advantages in terms of availability and visual detail, they also come with inherent limitations. Their reliance on visible light means they are sensitive to lighting conditions, shadows, and occlusions. They also lack depth and material information, which can be crucial for disambiguating visually similar objects or for understanding three-dimensional structures.

Existing approaches, including those based on foundation models (FMs) such as Scale.ai and Labelbox, can provide some level of automation, but they often struggle with different imaging modalities and viewpoints and still require substantial human intervention. Certain methods utilize land cover data as ground truths, but they require additional alignment steps and do not include additional label refinement, which results in low-resolution semantic segmentation labels. These limitations have hindered progress in developing semantic perception algorithms for field robots. Nonetheless, RGB images remain widely used due to their practicality and the robust ecosystem of tools and frameworks built around them.

Thermal images, on the other hand, can be better suited for semantic segmentation and label generation in challenging conditions, as they capture heat signatures rather than visible light. This makes them more robust to variations in lighting, shadows, and weather and particularly effective in low-light or night-time scenarios where RGB images often fail. However, their broader adoption is limited by their low accessibility, where large, labeled thermal datasets are scarce. For example, the development of thermal scene perception for aerial field robotics has been hindered by a significant lack of annotated thermal data, especially for natural environments such as deserts, forests, and coastlines. Traditional methods of generating semantic segmentation labels rely heavily on manual labeling, which is not only time-consuming but also prohibitively expensive. This process often requires extensive travel for data collection and multiple rounds of expert review and is further complicated by the unique visual characteristics of thermal imagery. As a result, thermal imaging is rarely used despite its potential advantages.

Systems and methods in accordance with various embodiments provide a novel approach to generating high-quality semantic segmentation labels for aerial imagery, and specifically, thermal imagery, captured by different sources. Some embodiments leverage satellite-derived data products and advanced machine learning techniques to reduce the time and cost associated with annotating aerial field imagery. In a number of embodiments, systems and methods utilize an automated approach to enable rapid and cost-effective generation of semantic segmentation labels, potentially accelerating the development of semantic perception systems for various types of vehicles operating in both day and night conditions. Furthermore, the method's ability to work across different imaging modalities (e.g., thermal, RGB, near-infrared, etc.) and its relative insensitivity to distribution shifts make it a versatile tool for a wide range of applications.

In various embodiments, systems and methods leverage satellite land cover data as a source of ground truth and use FMs only for fine-grained refinement such that the systems are largely insensitive to distribution shifts. In many embodiments, systems and methods utilize scene perception for images captured by aerial field robotics to build annotated datasets for natural environments. Thermal images captured by unmanned aerial vehicles (UAVs) may be utilized to build annotated datasets. Various embodiments combine captured aerial images with Land Use and Land Cover (LULC) datasets and Digital Elevation Maps (DEM) datasets and leverage the information provided by the LULC and DEM datasets to generate labeled images that are correctly segmented.

In several embodiments, systems and methods derive Universal Transverse Mercator (UTM) coordinates of the capture device based on the locations of captured aerial images. Systems and methods in accordance with numerous embodiments leverage information contained in the LULC and DEM datasets regarding the location of an aerial image and warp the information contained in the LULC and DEM datasets into the frame of the capture device such that the generated labels include all the information provided by the aerial imagery and the LULC and DEM datasets as if the capture device took a colored picture of the desired location. In certain embodiments, systems and methods include an automatic refinement step that corrects misalignments and enables the production of high-resolution semantic segmentation labels even with low-resolution satellite land cover data.

Systems and methods in accordance with a variety of embodiments can be adapted for imagery captured from ground vehicles, such as for self-driving car applications. In some embodiments, apart from thermal imagery, label generation methods can annotate RGB and near-infrared imagery. Satellite land cover data may be substituted with land cover data derived from orthorectified aerial imagery. In this scenario, an operator would capture nadir-facing images covering the entire area of interest with an aerial vehicle, which can then be orthorectified, stitched, and labeled using either manual labeling or a land cover segmentation model before the primary set of non-nadir-facing images can be annotated.

### Automatic Generation of Semantic Segmentation Labels

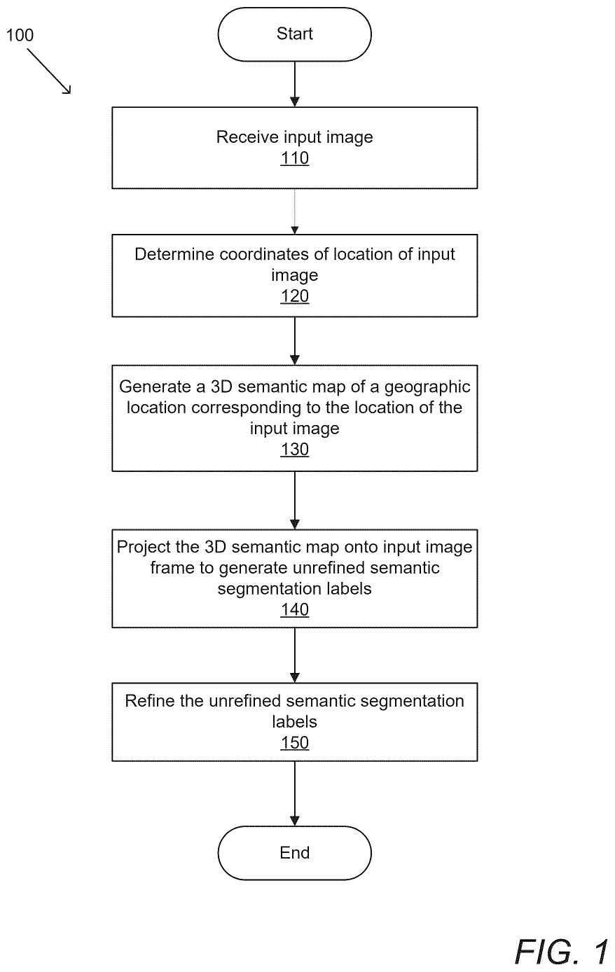

Systems and methods in accordance with various embodiments automatically generate semantic segmentation labels for input imagery by transforming input data into refined semantic segmentation labels. A process for generating semantic segmentation labels for input images in accordance with an embodiment is illustrated in FIG. 1. Process 100 receives (110) an input image. Input images in accordance with various embodiments are captured by imaging platforms on UAVs. In certain embodiments, input images may be thermal images in a format that represents temperature variations across the captured scene, typically in grayscale. Input images may include but are not limited to RGB, near-infrared (NIR) images, etc.

Process 100 determines (120) location data of the input image. Location data in accordance with a number of embodiments is a set of coordinates for the location of the input image. In various embodiments, the set of coordinates are UTM coordinates. Coordinates in accordance with several embodiments may be derived from GPS data associated with the UAV at the time of image capture and can provide precise geographic positioning for the captured image.

Process 100 generates (130) a 3D semantic map of a geographic location that corresponds to the location of the input image. In many embodiments, 3D semantic maps contain pre-classified LULC data and DEM data. Processes in accordance with various embodiments can transform the coordinate systems of the LULC, DEM, and UAV into a common reference frame, typically using UTM coordinates. Transforming the coordinate systems into a common reference frame enable all data sources to be accurately overlaid and compared. Processes in accordance with many embodiments incorporate elevation information from the DEM data into the LULC data to generate a 3D semantic map representation of the land cover. In many embodiments, elevation information from the DEM data is assigned to each LULC classification pixel. LULC data may be obtained from sources such as Dynamic World or OpenEarthMap, and may include multiple classes such as (but not limited to) water, vegetation, built-up areas, bare ground, etc.

Process 100 projects (140) the 3D semantic map onto the input image frame to generate unrefined semantic segmentation labels. In many embodiments, systems and methods project the 3D semantic data to the 2D perspective of the input image by warping the world coordinates of the 3D semantic map into the camera coordinate frame. Processes in accordance with a number of embodiments may use the UAV's position, altitude, and orientation data to transform classification information included in the 3D semantic map to match the input image's viewpoint. In various embodiments, processes extract relevant portions of the 3D semantic map associated with the location of the input image to obtain the classification information associated with the relevant portions and apply perspective transformation to project classification to each pixel of the input image frame. Processes in accordance with certain embodiments may resample to match the input image resolution. 3D semantic maps can allow for more accurate projections of the land cover onto the frame of the input image, especially in areas with significant topographic variation.

Process 100 refines (150) the unrefined semantic segmentation labels. In many embodiments, unrefined labels are refined using binary segmentation masks generated by a Segment Anything Model (SAM) to improve the accuracy and detail of the segmentation. Processes in accordance with several embodiments may take into account the input image's unique characteristics to adjust boundaries and classifications based on temperature patterns and spatial relationships. Refined labels may be in the form of a pixel-wise classification map that corresponds to the input image.

While specific processes are described above with reference to FIG. 1, any of a variety of methods for semantic segmentation label generation in any of a variety of different modes can be utilized as appropriate to the requirements of specific applications in accordance with various embodiments of the invention.

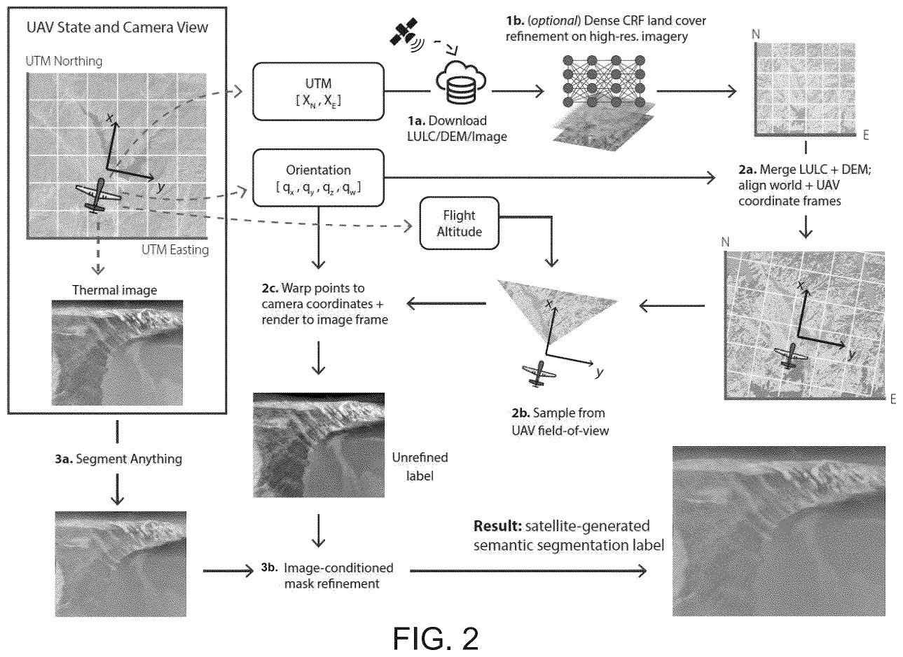

A method for automatically generating semantic segmentation labels based on aerial thermal imagery in accordance with an embodiment is illustrated in FIG. 2. In various embodiments, label generation methods obtain the coordinates, orientation parameters, and flight altitude information of the UAV where its onboard imaging systems captured a thermal image. At step 1a, systems and methods obtain various types of data to generate semantic segmentation labels. Data may include satellite raster data, and the thermal image captured by the UAV. Satellite raster data in accordance with many embodiments can include but are not limited to LULC and DEM data for the region surrounding the location where the thermal image was captured. A dense conditional random field (CRF) land cover refinement may optionally be performed at step 1b to increase the resolution of the obtained satellite raster data.

In step 2a, satellite raster data such as the LULC and DEM data are merged to create a 3D semantic map that contains elevation and classification information for each pixel of the 3D semantic map. World and UAV coordinate frames may be aligned such that the 3D semantic map and the UAV are on a common reference frame, and the 3D semantic map can accurately correspond to the perspective of the aerial thermal imagery. In various embodiments, label generation methods sample from the UAV's field-of-view at step 2b and warps points from the UAV's field-of-view to camera coordinates to render them in the image frame at step 2c to generate an unrefined label. Label generation methods in accordance with various embodiments perform 3D geometric transformations to project the 3D semantic map onto the 2D plane of the thermal image.

Step 3a includes a segmentation stage to process the original thermal image to generate an initial segmentation mask. In many embodiments, initial segmentation masks are generated using a SAM to capture fine details between segmentation instances. In step 3b, the generated segmentation mask can be applied to the unrefined label through image-conditioned mask refinement to produce a refined semantic segmentation label. In a number of embodiments, refined semantic segmentation labels can be used for various purposes, such as training machine learning models or evaluating existing perception algorithms. Label generation processes leverage freely available satellite raster data alongside onboard sensor measurements from the aerial platform to generate accurate and detailed semantic labels for thermal imagery.

The system depicted in FIG. 2 may be implemented using various hardware and software components, including but not limited to servers, cloud computing resources, and specialized image processing hardware. The modular nature of the pipeline allows for potential customization and optimization of individual stages to suit specific application requirements or to incorporate new data sources or processing techniques as they become available.

In numerous embodiments, systems and methods leverage publicly available LULC datasets like Dynamic World and Impact Observatory that are derived from satellite rasters obtained through the Sentinel-2 program. These datasets offer a relatively low spatial resolution of 10 meters per pixel but provide global coverage. They are updated using semantic segmentation networks that leverage multiple spectral bands for land cover classification. Although daily updates are possible, actual availability is often limited by factors such as cloud cover. In contrast, high-resolution LULC data such as the Chesapeake Bay Program and OpenEarthMap offer sub-meter resolution but are limited in geographical and temporal coverage. While segmentation models can be trained on these datasets with high-resolution imagery, they may not generalize to different geographical areas.

High-resolution raster imagery includes imagery from aerial vehicles and satellites. Aerial imagery providers include the National Agricultural Imagery Program (NAIP), while satellite imagery comes from providers like Planet, Maxar, and Airbus. Image resolutions range from 0.3 meters per pixel to 3 meters per pixel. Imagery can be available daily at a premium cost, while free alternatives are captured triannually.

Lidar-derived 3D data products include digital surface (DSM) and digital elevation models (DEM) are raster data whose values denote the height at the corresponding geographic lo-cation. DSMs consider features above the ground like foliage and rocky terrain while DEMs report bare earth elevation. Many embodiments utilize DEMs and DSMs with 1-3 meters-per-pixel resolution from the 3D Elevation Program (3DEP) from the United States Geological Survey.

In certain embodiments, relevant satellite data, including but not limited to LULC rasters, DEM or DSM, and high-resolution imagery around the UAV's global position are downloaded and resampled to the highest resolution via bicubic interpolation. To simplify future calculations, various embodiments convert the coordinates of the satellite data to UTM coordinates before merging the DEM and LULC rasters. Since the current freely available LULC data is low resolution, they may be refined by conditioning on high-resolution imagery. In selected embodiments, LULC data are refined using dense CRFs to enhance 10 meters per pixel resolution LULC rasters with 1 to 3 meters per pixel resolution aerial imagery.

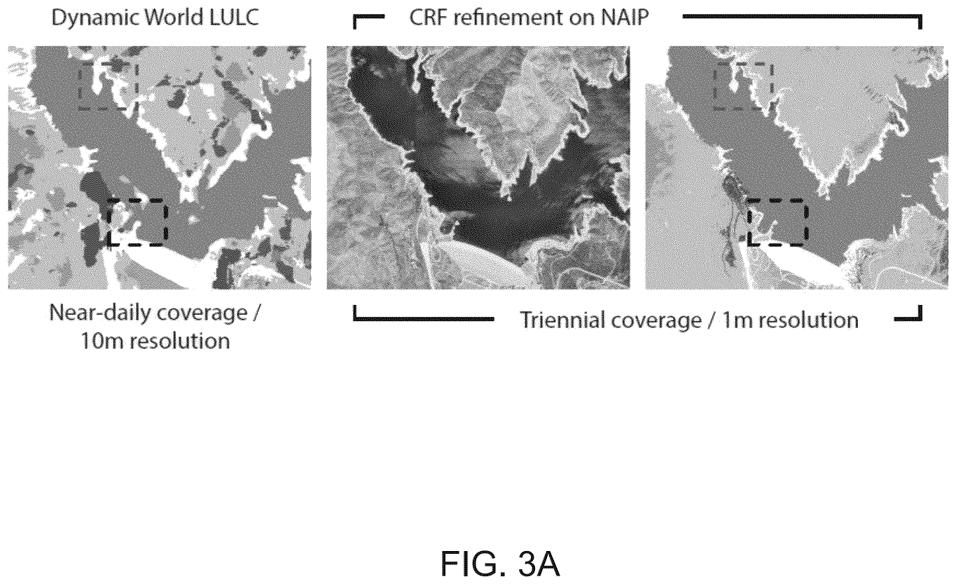

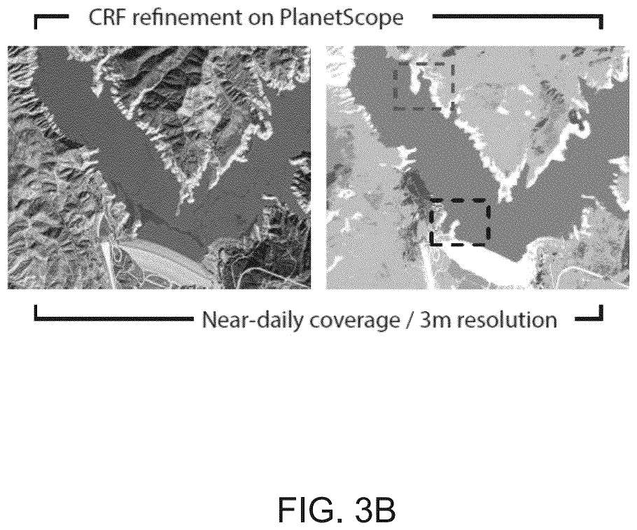

Dense CRF refinements of Dynamic World land cover raster using NAIP and PlanetScope imagery of Castaic Lake, CA, in accordance with an embodiment is illustrated in FIGS. 3A-3B. As illustrated in FIG. 3B, results refined via PlanetScope can convey the actual scenery at the time of thermal image capture due to its high revisit frequency but at a lower 3 meters-per-pixel spatial resolution. NAIP refinement as illustrated in FIG. 3A can offer 1 meters-per-pixel resolution but is susceptible to changes in the terrain (notably, water levels of lakes) due to its triennial capture cycle.

To summarize, a dense CRF is defined by a Boltzmann distribution with energy function:

$$E ( X \vert I ) = {\sum }_{i} {ψ}_{u} ( {x}_{i} \vert {I}_{i} ) + {\sum }_{i < j} {ψ}_{p} ( {x}_{i} , {x}_{j} \vert {I}_{i} ) \qquad ( 1 )$$

This function models the relationship between labels x∈X and the conditioning image I∈ [symbol] ^{H×W×C}. In equation 1, ψᵤ is a unary potential taken to be raw logits from a semantic segmentation network and ψₚ is a pairwise potential that encourages label consistency among adjacent pixels with similar intensities.

ψᵤ can be set to be the logits from the model that generates labels for the LULC data. A generalized ψₚ may be used to condition multi-band raster images:

$${ψ}_{p} ( {f}_{i} , {f}_{j} ) = μ \cdot [ {w}^{( 1 )} {e}^{( - \frac{1}{2} {\overline{p}}_{ij}^{T} {\sum }_{α} {\overline{p}}_{ij} - \frac{1}{2} {\overline{I}}_{ij}^{T} {\sum }_{β} {\overline{I}}_{ij} )} + {w}^{( 2 )} {e}^{( - \frac{1}{2} {\overline{p}}_{ij}^{T} {\sum }_{γ} {\overline{p}}_{ij} )} . \qquad ( 2 )$$

p̅ᵢⱼ=[pᵢ−pⱼ]∈ [symbol] ³ is the difference between the positions of pixels i and j, and Īᵢⱼ=[Iᵢ−Iⱼ]∈ [symbol] ^{C} is the difference between image features at pixels i and j. μ may be set as the standard Potts compatibility function.

In various embodiments, systems and methods optimize the CRF by w⁽¹⁾ and w⁽²⁾, and the Gaussian bandwidth parameters Σ_{α}=θ_{α}, Σ_{γ}=θ_{γ}, and

$${\sum }_{β} = diag ( {θ}_{β}^{( 1 )} , … , {θ}_{β}^{( C )} ) .$$

used instead of cross entropy to account for imprecise labels at class boundaries due to low LULC resolution. Alternatively, high-resolution LULC can also be created using a pretrained LULC segmentation network on high resolution imagery.

To generate an LULC-derived semantic label for an image at time t, systems and methods in accordance with many embodiments transform the world coordinates of each pixel X_{w}∈ [symbol] ³ into the camera coordinate frame. In several embodiments, systems and methods utilize the position of the host

$$UAV {X}_{t}^{uav} ∈ {ℝ}^{3} ,$$

which includes the onboard Extended Kalman Filter (EKF)-fused GPS position and barometric altitude, the orientation quaternion qₜ ∈ [symbol] taken from the EKF-fused inertial measurement unit (IMU) readings and the offset between the aircraft and camera reference points. Using a calibrated camera intrinsic matrix K, world coordinates may be projected to image frame coordinates of the camera on the host

$$UAV {x}_{t}^{c} ∈ {ℤ}^{2} .$$

Formally, this may be represented as:

$$[ \begin{matrix}{x}_{t}^{c} \\ 1\end{matrix} ] = K [ \begin{matrix}R ( {q}_{t} ) & T ( {x}_{t}^{uav} ) \\ {0}_{1 \times 3} & 1\end{matrix} ] [ \begin{matrix}{X}_{w} \\ 1\end{matrix} ] , \qquad ( 3 )$$

where R is a rotation matrix and T is a translation vector. By using the camera intrinsic matrix K and the extrinsic matrix that includes R and T, world coordinates of each pixel of the image can be transformed to the image frame coordinates of the UAV camera. OpenGL in accordance with some embodiments were used to render the projected LULC, using 3D co-ordinates as vertices, associated class labels as vertex colors, and depth-testing to avoid rendering occluded semantics.

In certain embodiments, only 3D semantics within a specified distance in front of and on both sides of the camera were utilized in label generation to optimize memory and speed. Spacing between sampled vertices may be increased as the distance from the camera increases, exploiting the compression of far-field points in the image frame. In selected embodiments, only 250×200 points may be needed when rendering within a 10 km×8 km bounding box.

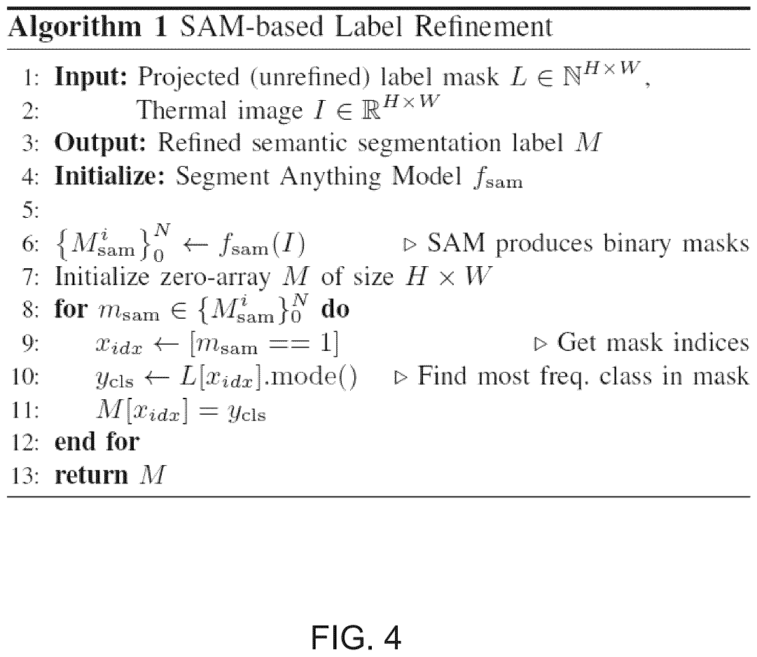

Rendered semantic segmentation labels may not align well with the thermal images due to poor spatial resolution and temporal misalignment, as well as errors in LULC label generation and camera pose estimation. To improve alignment, labels may be refined using binary segmentation masks of the corresponding thermal image generated using the SAM. An algorithm for SAM-based label refinement in accordance with an embodiment is illustrated in FIG. 4. The algorithm takes as input a projected (unrefined) label mask and a thermal image to produce an output that is a refined semantic segmentation label. The algorithm initializes by setting up a SAM model to produce binary masks. Given an initial projected label mask and a thermal image, SAM may be used to generate binary segmentation masks that identify coherent regions in the image. In many embodiments, refinement algorithms determine, for each region, the most frequent label from the projected mask and assign it uniformly across that region, producing a refined label map. This process can enhance alignment between semantic labels and actual thermal image features, correcting projection errors and producing cleaner, more accurate segmentation.

In some embodiments, SAM-based refinement processes may be particularly useful for addressing issues such as misalignment between the projected labels and the actual features in the thermal image or for capturing fine details that may not be present in the initial satellite raster data. The algorithm's ability to work with binary masks from the SAM model allows it to leverage state-of-the-art segmentation techniques while maintaining semantic information from the original projected labels.

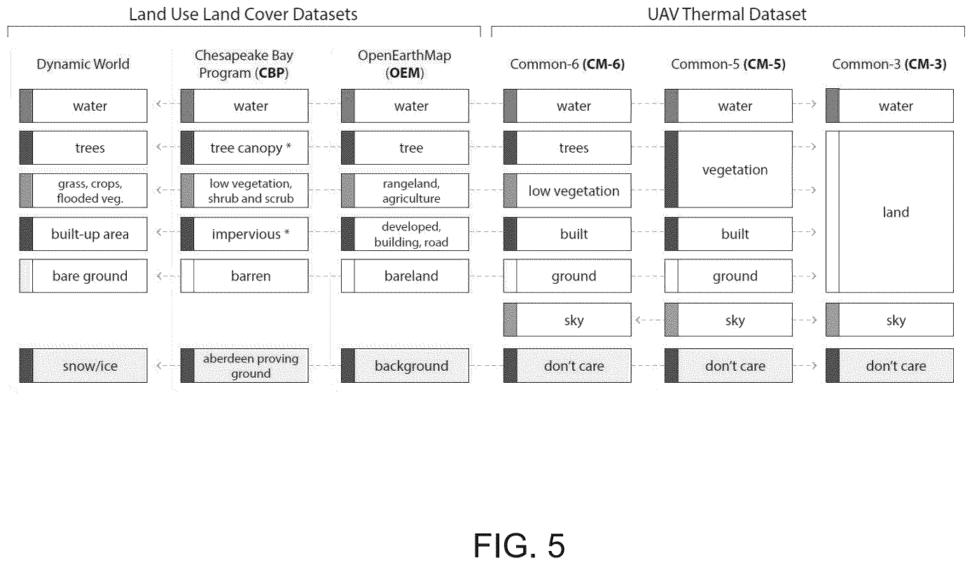

An evaluation of the disclosed method was conducted using a low-altitude thermal aerial robotics dataset comprising off-nadir (20°-45°) views of diverse geographic features, including riverine environments (Kentucky River, KY and Colorado River, CA), lakes (Castaic Lake, CA), and coastal regions (Duck, NC). A mapping of the original and consolidated segmentation labels in accordance with an embodiment is illustrated in FIG. 5. The dataset was collected using a multirotor aerial platform across 15 distinct flight trajectories at altitudes ranging from approximately 40 to 100 meters. Each flight captured synchronized thermal imagery along with corresponding GPS and IMU data. Four of the trajectories were excluded from analysis due to errors in GPS data acquisition. The dataset includes ground truth semantic segmentation labels for ten original classes. For the purposes of evaluation and alignment with common land cover taxonomies, the class set was consolidated into six categories (denoted CM-6), yielding 1,304 sub-sampled images with corresponding six-class ground truth labels. Two additional class sets were derived by further consolidating the categories into five-class (CM-5) and three-class (CM-3) configurations to support experiments at varying levels of semantic granularity.

### Results

Label generation method in accordance with one embodiment was evaluated using an experiment setup discussed below involving the acquisition and processing of multiple geospatial and remote sensing data products. Raster data was obtained from a variety of sources, including 10-meter resolution LULC data from Dynamic World, as well as three-dimensional terrain data products from the USGS 3DEP, specifically including 3-meter DEMs, 1-meter DEMs, and 2-meter digital surface models (DSMs). High-resolution nadir imagery was also incorporated, with 1-meter resolution imagery from the NAIP and 3-meter resolution imagery from PlanetScope. Data access was facilitated through the Microsoft Planetary Computer and Google Earth Engine platforms.

To generate additional high-resolution LULC rasters, neural networks trained on the CBP and OpenEarthMap (OEM) datasets were employed. OEM-based LULC products were produced using a pre-trained U-Net segmentation model. For CBP-based LULC generation, a geospatial foundation model was fine-tuned on the CBP dataset, using a seven-class configuration consistent with existing land cover datasets. Model training was conducted for 1,000 epochs with a batch size of 16, a learning rate of 1e-3, and 512×512 input patches comprising RGB and NIR channels. Inference on large raster inputs was performed using tiled evaluation with 50% overlap, along with horizontal and vertical flip-based test-time augmentation.

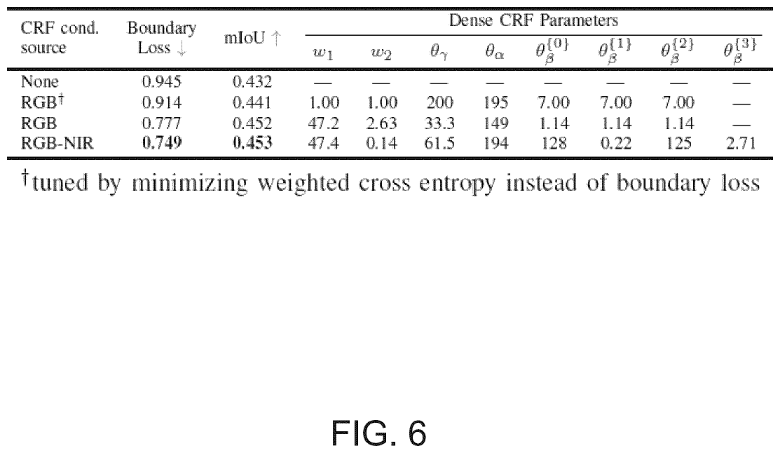

An evaluation of dense CRF refinement of Dynamic World LULC on NAIP imagery with ground truth labels from CBP in accordance with an embodiment is illustrated in FIG. 6. Refinement of the Dynamic World LULC outputs was carried out using dense CRFs, applied to RGB-NIR imagery from NAIP and Planet, as illustrated in FIGS. 3A-3B. CBP refinement parameters, as shown in FIG. 6. were selected via Bayesian optimization using the Optuna framework, with optimization conditioned on NAIP imagery and 1-meter resolution CBP-derived labels serving as reference ground truth. The empirical evaluation showed that a boundary-aware loss function yielded improved performance over the standard cross-entropy loss for this use case.

In the label generation pipeline, the SAM was employed to refine the projected LULC labels. The default ViT-H model was used, with prompt points arranged in a uniform 32×32 grid over the image. The non-maximum suppression (NMS) threshold for bounding box filtering was reduced to 0.5 to promote finer segmentation granularity.

Thermal images utilized in the experiment were preprocessed to rescale raw 16-bit pixel intensities to the range between the 2nd and 98th percentiles before applying a contrast-limited adaptive histogram equalization using a clip limit of 0.02. These steps were performed to enhance contrast in both visualizations and algorithmic inputs, ensuring compatibility across downstream processing components.

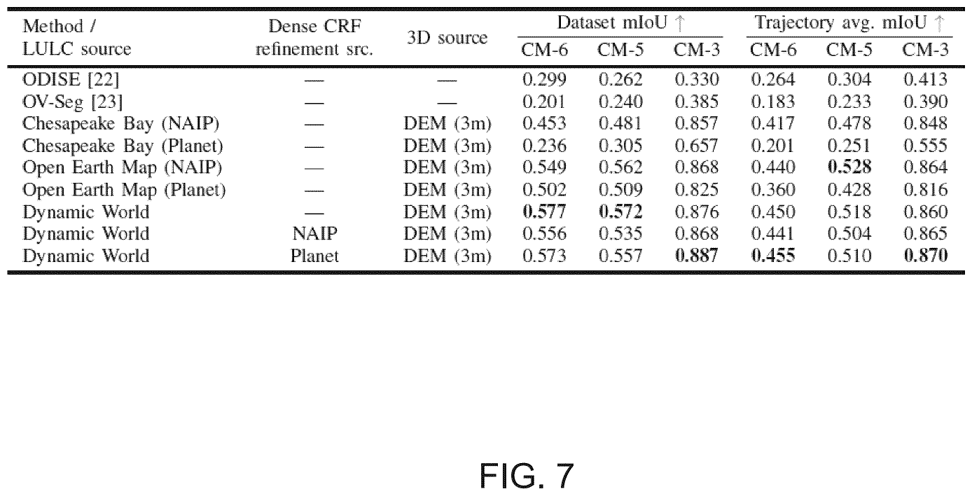

Semantic segmentation labels generated using methods disclosed herein were also evaluated against manually annotated ground truth labels. Due to class set discrepancies between LULC products and the ground truth, evaluation was performed across three derived label sets of increasing semantic generality: CM-6, CM-5, and CM-3. Quantitative performance was measured using both dataset-wide mean Intersection-over-Union (mIoU) and trajectory-averaged mIoU. An evaluation of LULC-generated semantic segmentation labels against ground truth labels, with comparisons against zero-shot visual foundation model baselines in accordance with an embodiment is illustrated in FIG. 7. The experimental results demonstrate that the disclosed method produces thermal semantic segmentation labels that are highly consistent with manually annotated ground truth. In particular, the best-performing configurations of the method significantly outperformed state-of-the-art zero-shot segmentation baselines, including ODISE and OV-Seg, even when those models were explicitly prompted with class definitions present in the evaluation dataset. While such models occasionally yielded plausible results on thermal imagery, their performance lacked consistency across the dataset.

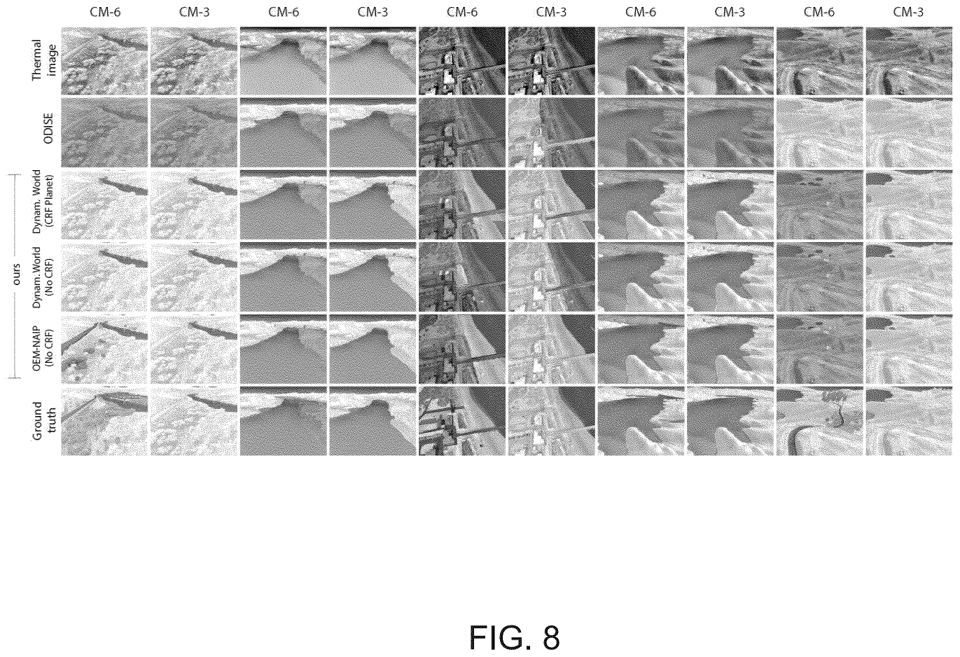

A series of example semantic segmentation outputs generated using a baseline method (ODISE), the disclosed method, and manually annotated ground truth (GT) in accordance with an embodiment is illustrated in FIG. 8. The segmentations are visualized using class mappings and color codes as described in FIG. 5. Differences between the CM-6 labels and the ground truth may be observed based on the underlying LULC data source, with such mismatches being substantially resolved in the more generalized CM-3 class set. Classes consisting of small, sparse, or narrow features—such as low vegetation and built structures in the CM-6 set—are more difficult to render accurately due to the limited spatial resolution of LULC inputs and reduced thermal image contrast during the label refinement process.

Among configurations not employing LULC refinement, label generation using the Dynamic World dataset combined with a 3-meter resolution digital elevation model (DEM) consistently outperformed configurations using higher-resolution but pretrained LULC sources derived from CBP and OEM datasets. However, OEM-derived LULC rendered from NAIP imagery achieved marginal performance improvements in trajectory-averaged mIoU (ranging from approximately 0.005 to 0.01) over the Dynamic World baseline, particularly in the CM-5 and CM-3 configurations. This improvement is attributed to the higher spatial resolution (1 meter) of the OEM/NAIP-derived labels, which enables finer-grained segmentation of small or narrow class instances, such as roads, which are not well resolved in the coarser 10-meter Dynamic World data.

In contrast, LULC derived from Planet imagery exhibited degraded performance, primarily due to domain differences between the Planet data and the datasets used for training the OEM and CBP models. Nonetheless, when Planet imagery was employed to refine 10-meter Dynamic World labels using dense conditional random fields (CRFs), a modest improvement (˜0.01 mIoU) was observed on the CM-3 class set. This refinement effect was not replicated using NAIP imagery, likely due to terrain or land cover changes between the times of thermal image and NAIP capture.

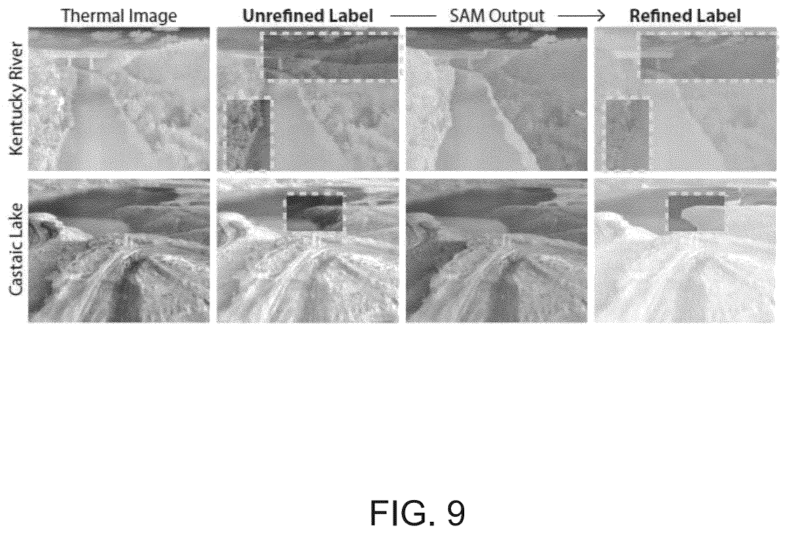

Systems and methods disclosed herein additionally demonstrate robustness to temporal mismatches between satellite raster and thermal imagery inputs. A rendered label refinement process with SAM in accordance with an embodiment is illustrated in FIG. 9. As illustrated by FIG. 9, in scenarios involving natural environmental variations such as shifting coastal tide lines or fluctuating water levels in lakes, the refinement step using the SAM effectively mitigates temporal inconsistencies. SAM's ability to segment full class instances allows the system to tolerate partial discrepancies in class geometry, provided that the core class presence remains discernible.

Based on performance and accessibility, the Dynamic World dataset is identified as a practical and cost-effective semantic source for LULC-based segmentation label generation. The utility of this source may be enhanced through optional refinement using high-resolution, temporally aligned imagery. It is anticipated that future advances in LULC product resolution and availability, particularly sub-meter datasets with frequent update cycles-will further improve the precision and applicability of the disclosed method.

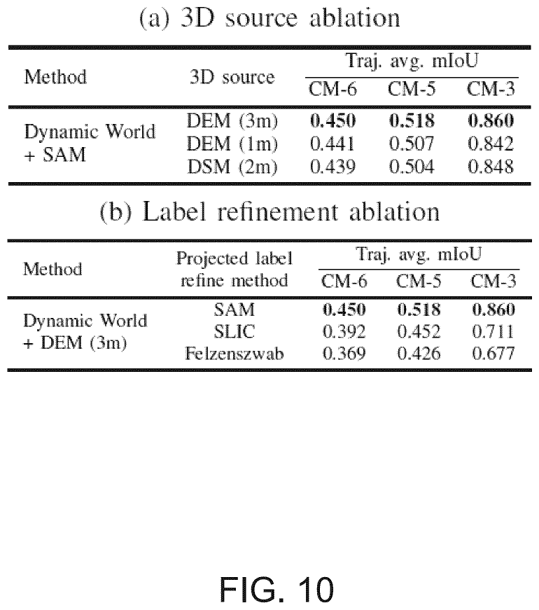

In a set of ablation studies, the Dynamic World dataset was utilized as the default source for LULC classification unless otherwise specified. The three-dimensional context was incorporated using a 3-meter resolution DEM, and CRF refinement was omitted for baseline evaluations. Data of ablation studies in accordance with an embodiment is illustrated in FIG. 10.

In one comparative analysis, the impact of different three-dimensional data sources on semantic segmentation label generation was assessed. Specifically, label generation using 3 m DEMs was compared to configurations using 2 m DSMs and 1 m DEMs. Due to incomplete spatial coverage in the dataset, 3 m DEMs were used in areas lacking DSM or 1 m DEM data (e.g., Colorado River and Duck regions). Results indicated that the 3 m DEMs consistently achieved higher trajectory-averaged mean Intersection-over-Union (mIoU) across all three class sets (CM-6, CM-5, and CM-3), despite the theoretically higher accuracy of the finer-resolution elevation data. This outcome is attributed to potential temporal or spatial misalignment issues in the orthorectification of higher-resolution products. Nevertheless, all 3D terrain data sources demonstrated sufficient performance, and any one of them may be used with the disclosed method, depending on availability.

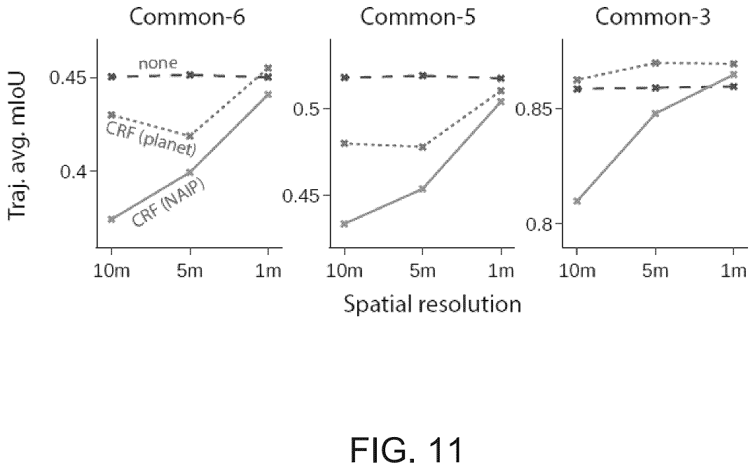

To evaluate the influence of LULC raster resolution on label quality, the Dynamic World data was resampled to three spatial resolutions: 10 m (native), 5 m, and 1 m. Nearest neighbor interpolation was applied directly to the LULC rasters, while CRF refinement was performed using NAIP and Planet imagery that had been resampled to matching resolutions via bicubic interpolation. The effect of LULC spatial resolution on semantic segmentation label generation in accordance with an embodiment is illustrated in FIG. 11. The experimental findings, as illustrated in FIG. 11, indicate that the spatial resolution of the LULC data plays a more significant role when evaluating more detailed class sets (e.g., CM-6 and CM-5). As the class sets become more generalized (e.g., CM-3), the importance of resolution diminishes. Moreover, the application of CRF refinement yielded greater improvements when paired with higher-resolution imagery, particularly for small or thin classes that occupy minimal pixel areas and are more prone to omission during low-resolution refinement.

A further comparison was conducted between the SAM and traditional superpixel-based segmentation methods for the refinement of projected LULC labels. Specifically, SAM was evaluated against SLIC and Felzenszwalb superpixel algorithms, both implemented using the scikit-image library. Parameters for SLIC were set to 100 segments with compactness of 10, while the scale parameter for the Felzenszwalb method was configured at 1e⁴. These parameters were selected to maximize coverage of semantically consistent regions while preserving class boundaries.

The results demonstrate that SAM outperformed both classical methods in terms of mIoU, with observed performance margins increasing by up to 0.06, as illustrated in FIG. 10. SAM's ability to produce semantically meaningful masks in the thermal domain, although slightly less effective than in RGB domains, allowed the majority-voting process (as described in FIG. 4) to suppress minor projection inaccuracies. In contrast, the superpixel-based methods produced fragmented and class-agnostic segmentations that contributed minimal value to label refinement.

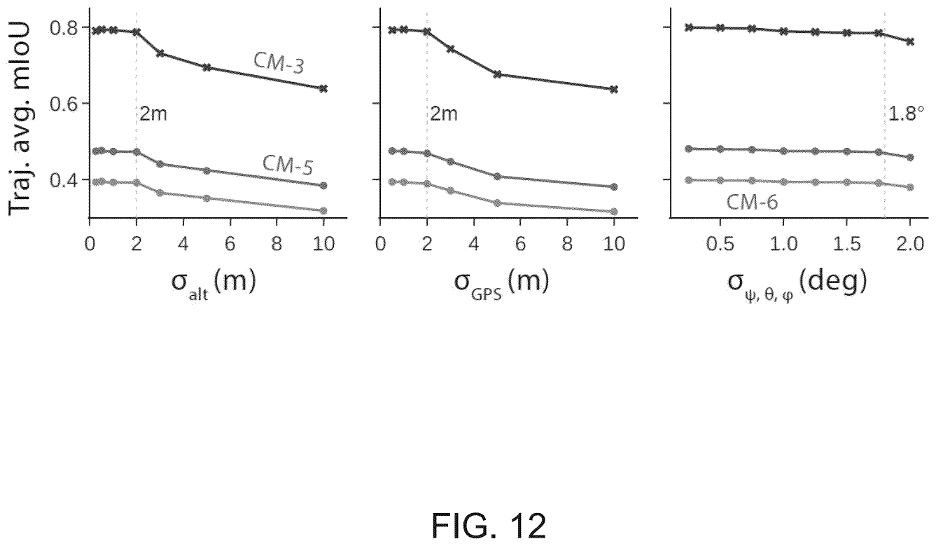

The robustness of the disclosed method to variations in global pose estimation accuracy was also examined. The effect of global pose estimate precision on semantic segmentation label generation with SAM refinement in accordance with an embodiment is illustrated in FIG. 12. To this end, synthetic perturbations were introduced to position and orientation estimates, sampled from normal distributions with increasing variance. The analysis confirmed that the label generation process remained stable with 95% confidence for positional errors up to approximately 4 meters and orientation errors up to approximately 3.5 degrees across all class sets. It was further observed that synchronizing the image capture timestamps with IMU data significantly improved projection accuracy. Additionally, the SAM refinement stage proved effective in mitigating the effects of minor attitude estimation errors, as evidenced in the Kentucky River dataset segment illustrated in FIG. 9.

Systems and methods in accordance with an embodiment was evaluated in the context of field robotics by training a semantic segmentation model using thermal imagery. Specifically, an Efficient ViT-B0 neural network architecture was employed, and training was conducted using an aerial thermal dataset with training, validation, and test splits derived from prior work. Three sets of training labels were generated using the present method, corresponding to the CM-6, CM-5, and CM-3 class groupings. Ground truth labels were converted to match these class sets to enable consistent evaluation. Network training was performed following a standard thermal image segmentation procedure as established in the referenced dataset.

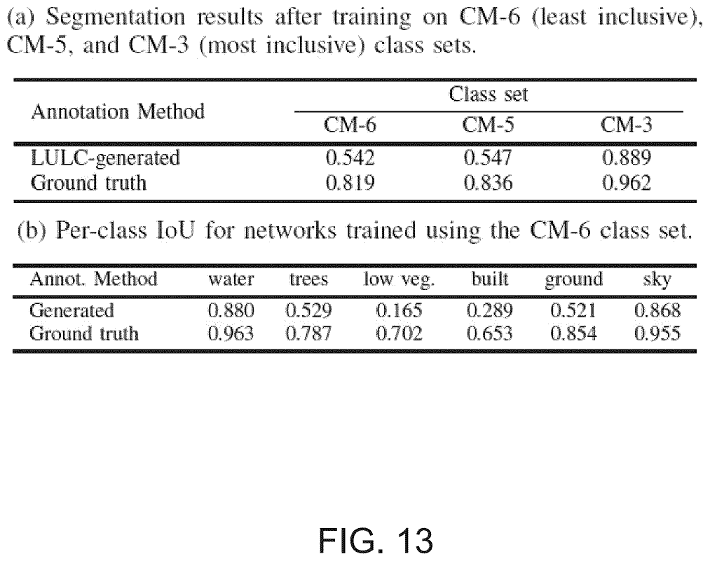

Test results of semantic segmentation networks trained on LULC-generated labels and networks trained on manually annotated ground truth in accordance with an embodiment is illustrated in FIG. 13. The performance of the trained models was assessed using mIoU on the test set, and the results were compared to the accuracy of models trained on manually annotated ground truth labels. For the CM-3 class set, the model trained using labels generated by the disclosed method achieved a mIoU of 0.889, compared to 0.962 for the model trained on ground truth. Although models trained on the more detailed CM-5 and CM-6 class sets showed greater performance gaps relative to ground truth-trained counterparts, they still demonstrated the efficacy of the proposed method. The reduced accuracy in these cases is attributed to limitations in rendering land-based classes such as low vegetation and built structures. These categories often include narrow or sparsely distributed features (e.g., shrubs or roads) that may not be accurately represented in the LULC source data or may be challenging to resolve in thermal imagery due to their low contrast and blurred appearance. Nevertheless, the disclosed method was found to be suitable for training effective semantic segmentation models, particularly for generalized class configurations—and is applicable to real-world field robotics tasks such as autonomous nighttime navigation in riverine environments.

In one embodiment, label generation process requires approximately three seconds per image, with approximately 2.86 seconds attributable to the SAM refinement step. When relying solely on Dynamic World LULC data, label generation processes in accordance with various embodiments can incur no cost. However, when dense CRF refinement is employed, the cost of labeling increases to approximately $10 USD per square kilometer due to the acquisition of high-resolution, near-real-time satellite imagery. The method enables the labeling of 2,000 thermal images in approximately 1.6 hours on a single standard workstation. This is in stark contrast to conventional manual labeling workflows, which typically require between two to four weeks and incur costs ranging from approximately $3,000 to $8,000 USD when outsourced. While CRF refinement may be cost-effective in scenarios involving large volumes of data over geographically concentrated areas-due to its fixed overhead structure, it is noted that approximately 98.5% of the segmentation performance (as measured on CM-6 and CM-3 class sets) can be achieved using only free, publicly available 10-meter resolution LULC data sources, such as Dynamic World.

### Hardware Implementation

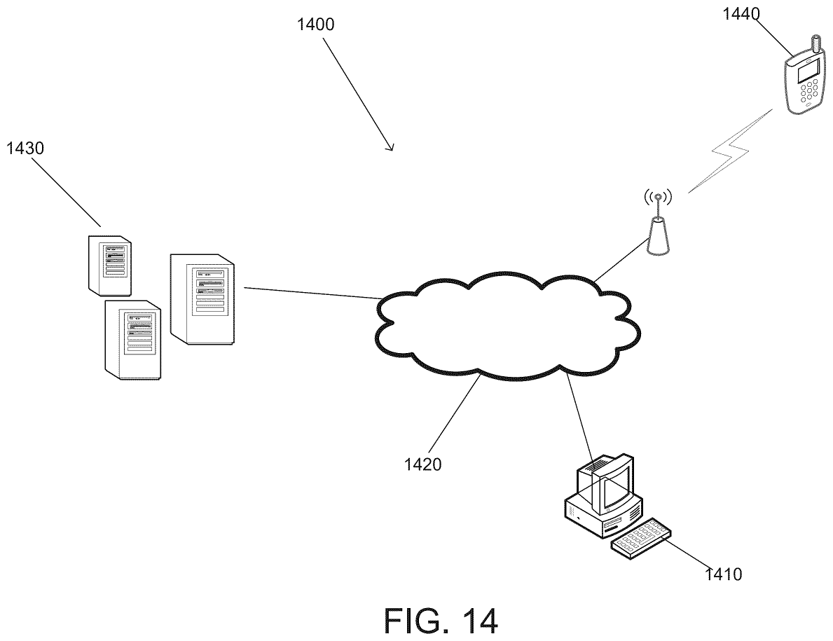

A network architecture for generating labels for semantic segmentation for training and inference tasks in accordance with an embodiment of the invention is illustrated in FIG. 14. Such embodiments may be useful where computing power is not possible at a local level and a central computing device (e.g., server) performs one or more features, functions, methods, and/or steps described herein. In such embodiments, a computing device 1410 (e.g., personal computer) is connected to a network 1420 (wired and/or wireless), where it can receive inputs from one or more computing devices, including data from a records database or repository containing video and/or image data, data provided from a personal computing device, and/or any other relevant information from one or more other remote devices 1410 and/or 1440. Once computing device 1410 performs one or more features, functions, methods, and/or steps described herein, any outputs can be transmitted to one or more computing devices 1410 for entering into records. Server systems 1430 may be a group of one or more servers communicatively connected to one another via internal networks that execute processes that provide cloud services for performing one or more features, functions, methods, and/or steps described herein to users over the network 1420. One skilled in the art will recognize that network architectures for generating labels for semantic segmentation for training and inference tasks may exclude certain components and/or include other components that are omitted for brevity without departing from this invention.

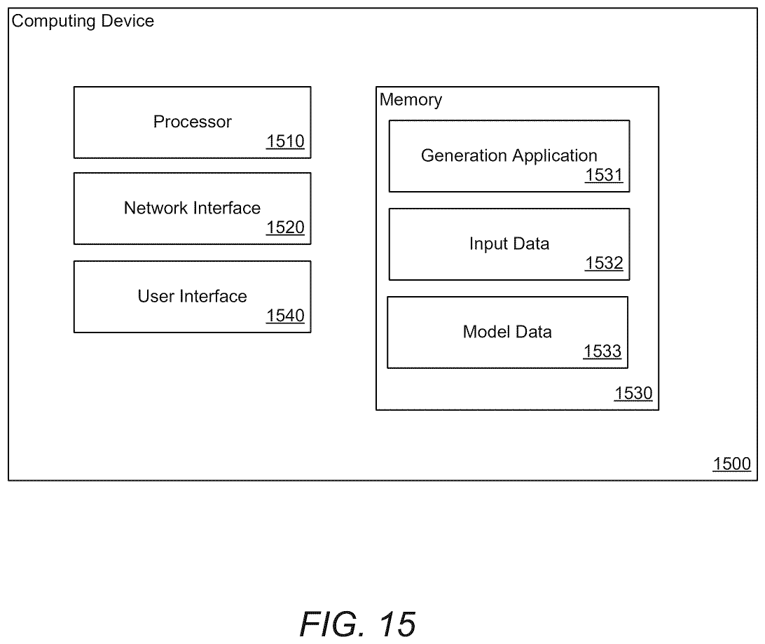

A computing device that can be utilized to generate labels for semantic segmentation for training and inference tasks in accordance with an embodiment of the invention is illustrated in FIG. 15. Computing device 1500 includes a processor 1510. Processor 1510 may direct the generation application 1531 to generate labels for semantic segmentation based on input data 1532 and model data 1533. Model data 1533 may include data to foundation models and may be used in situations where LULC data is generated using foundation models. In many embodiments, processor 1510 can include a processor, a microprocessor, a controller, or a combination of processors, microprocessor, and/or controllers that perform instructions stored in the memory 1530 to generate labels for semantic segmentation for training and inference tasks. Processor instructions can configure the processor 1510 to perform processes in accordance with certain embodiments of the invention. In various embodiments, processor instructions can be stored on a non-transitory machine-readable medium. Computing device 1500 further includes a network interface 1520 that can receive media data from external sources. Computing device 1500 may further include a user interface 1540 to allow for user control of the label generation process.

Although a specific example of a computing device is illustrated in this figure, any of a variety of computing devices can be utilized to generate labels for semantic segmentation for training and inference tasks similar to those described herein as appropriate to the requirements of specific applications in accordance with embodiments of the invention.

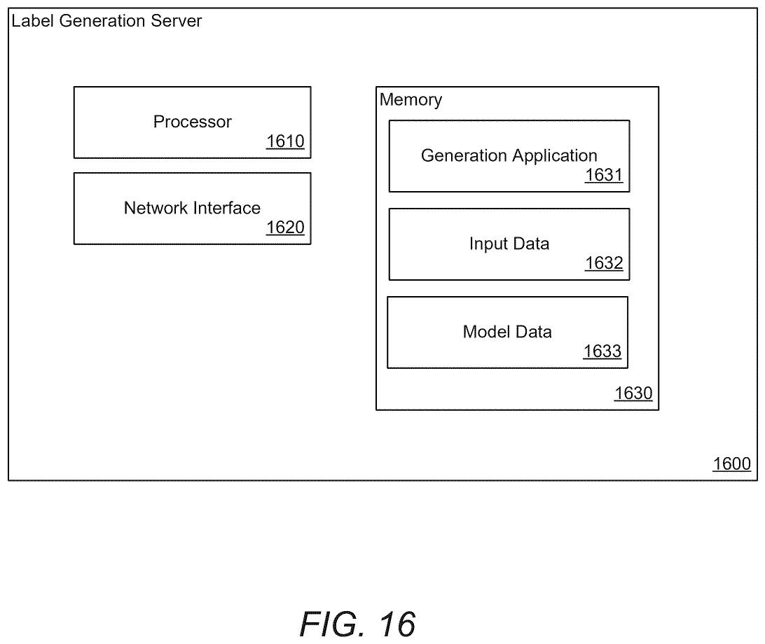

A label generation server that can be utilized to generate semantic segmentation labels for training and inference tasks in accordance with an embodiment of the invention is illustrated in FIG. 16. Label generation server 1600 includes a processor 1610. Processor 1610 may direct the generation application 1631 to generate labels for semantic segmentation based on input data 1632 and model data 1633. Model data 1633 may include data to foundation models and may be used in situations where LULC data is generated using foundation models. In many embodiments, processor 1610 can include a processor, a microprocessor, a controller, or a combination of processors, microprocessors, and/or controllers that perform instructions stored in the memory 1630 to generate semantic segmentation labels for training and inference tasks. Processor instructions can configure the processor 1610 to perform processes in accordance with certain embodiments of the invention. In various embodiments, processor instructions can be stored on a non-transitory machine-readable medium. Label generation server 1600 further includes a network interface 1620 that can receive data from external sources.

Although a specific example of a label generation server is illustrated in this figure, any of a variety of label generation servers can be utilized to generate semantic segmentation labels for training and inference tasks similar to those described herein as appropriate to the requirements of specific applications in accordance with embodiments of the invention.

In accordance with still other embodiments, the instructions for the processes can be stored in any of a variety of non-transitory machine-readable media appropriate to a specific application.

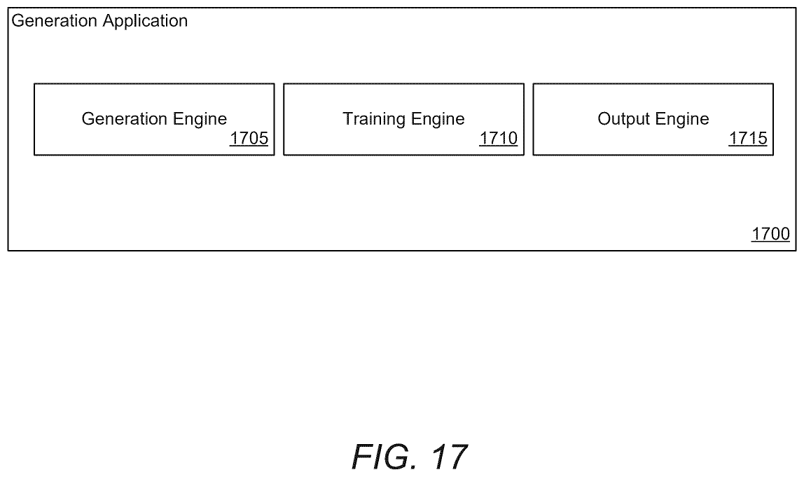

A generation application for generating semantic segmentation labels for training and inference tasks in accordance with an embodiment of the invention is illustrated in FIG. 17. Generation application 1700 includes generation engine 1705, training engine 1710, and output engine 1715.

Generation engines in accordance with a variety of embodiments can refine and transform input data to generate input with reduced perturbations, thereby potentially improving learning efficiency and diagnostic accuracy.

In many embodiments, training engines can compute the loss between generated satellite data and actual satellite data and use the computed loss to inform the backpropagation of foundation models that generated the satellite data.

Output engines in accordance with several embodiments of the invention can provide a variety of outputs to a user, including (but not limited to) preprocessed inputs, generated predictions, energy scores, confidence levels, notifications, and/or alerts. For example, output engines in accordance with various embodiments of the invention can provide a comparison of preprocessed input against the original inputs.

Although a specific example of an inference application is illustrated in FIG. 17, any of a variety of inference applications (e.g., with more or fewer modules) can be utilized to perform processes similar to those described herein as appropriate to the requirements of specific applications in accordance with embodiments of the invention.

Although specific methods of generating semantic segmentation labels for training and inference tasks are discussed above, many different methods of label generation can be implemented in accordance with various embodiments of the invention. For example, one of ordinary skill in the art will appreciate that methods of training and label generation described above can be implemented in a variety of computing and/or networking applications. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for generating labeled data for semantic segmentation, the method comprising:
receiving an input image of a geographic region captured by a camera on an aerial vehicle during flight;
obtaining pose data associated with the aerial vehicle;
generating a 3D semantic map of a geographic region corresponding to the geographic region in the input image;
projecting the 3D semantic map onto an input image frame using the pose data to generate a projected semantic label that aligns semantic classifications of the 3D semantic map with corresponding regions in the input image; and
refining the projected semantic label using a visual model conditioned on features of the input image to generate an output semantic segmentation label.

2. The method of claim 1, wherein the input image comprises a thermal image, an RGB image, and a near-infrared image.

3. The method of claim 1, wherein the pose data associated with the aerial vehicle comprises location and orientation parameters corresponding to the location of the input image.

4. The method of claim 1, wherein the 3D semantic map and the pose data associated with the aerial vehicle are transformed into a common coordinate system.

5. The method of claim 4, wherein the common coordinate system is a Universal Transverse Mercator (UTM) coordinate system.

6. The method of claim 1, wherein the 3D semantic map comprises land cover classifications and elevation data of the geographic region, wherein the elevation data is assigned to each pixel of the 3D semantic map.

7. The method of claim 1, wherein the 3D semantic map comprises data selected from the group consisting of: Dynamic World land use and land cover data (LULC), OpenEarthMap-derived LULC, and Chesapeake Bay Program-derived LULC.

8. The method of claim 1, wherein the visual model comprises a foundation model configured to output a binary mask based on the input image, and wherein the foundation model is a Segment Anything Model (SAM).

9. The method of claim 1, wherein refining the projected semantic label comprises:
generating a plurality of binary masks from the input image using the visual model;
for each binary mask, determining a most-frequent class label based on the projected semantic label; and
assigning the most-frequent class label to all pixels within the binary mask.

10. The method of claim 1, wherein the projection of the semantic map includes applying a transformation based on parameters of the camera and elevation data derived from a digital elevation model (DEM).

11. The method of claim 1, further comprising preprocessing the input image by applying intensity normalization and contrast-limited adaptive histogram equalization.

12. The method of claim 1, wherein the refined semantic segmentation label is used to train a machine learning model for real-time semantic perception in a field robotics system.

13. The method of claim 7, further comprising refining the LULC data using a dense conditional random field (CRF) model prior to projecting the LULC data into the input image frame, wherein the CRF is conditioned on high-resolution satellite imagery.

14. A non-transitory machine readable medium containing processor instructions, where execution of the instructions by a processor causes the processor to perform a process for generating labeled data for semantic segmentation, the process comprising:
receiving an input image of a geographic region captured by a camera on an aerial vehicle during flight;
obtaining pose data associated with the aerial vehicle;
generating a 3D semantic map of a geographic region corresponding to the geographic region in the input image;
projecting the 3D semantic map onto an input image frame using the pose data to generate a projected semantic label that aligns semantic classifications of the 3D semantic map with corresponding regions in the input image; and
refining the projected semantic label using a visual model conditioned on features of the input image to generate an output semantic segmentation label.

15. The non-transitory machine readable medium of claim 14, wherein the pose data associated with the aerial vehicle comprises location and orientation parameters corresponding to the location of the input image.

16. The non-transitory machine readable medium of claim 14, wherein the 3D semantic map and the pose data associated with the aerial vehicle are transformed into a common coordinate system.

17. The non-transitory machine readable medium of claim 14, wherein the 3D semantic map comprises land cover classifications and elevation data of the geographic region, wherein the elevation data is assigned to each pixel of the 3D semantic map.

18. The non-transitory machine readable medium of claim 14, wherein the visual model comprises a foundation model configured to output a binary mask based on the input image, and wherein the foundation model is a Segment Anything Model (SAM).

19. The non-transitory machine readable medium of claim 14, wherein refining the projected semantic label comprises:
generating a plurality of binary masks from the input image using the visual model;
for each binary mask, determining a most-frequent class label based on the projected semantic label; and
assigning the most-frequent class label to all pixels within the binary mask.

20. The non-transitory machine readable medium of claim 14, wherein the projection of the semantic map includes applying a transformation based on parameters of the camera and elevation data derived from a digital elevation model (DEM).
